(19) United States
(12) Patent Application Publication
(10) Pub. No.: US 2005/0222815 A1
(43) Pub. Date: Oct. 6, 2005

(54) System and method for testing and certifying products

(76) Inventor: Kevin Tolly, Sea Girt, NJ (US)

Correspondence Address: Michael R. Friscia;Wolff & Samson PC, One Boland Drive, West Orange, NJ, 07052, US

(21) Appl. No.: 10/814,599

(22) Filed: Mar. 31, 2004

(51) Int. Cl. G06F 11/30

(52) U.S. Cl. 702/185

(57) ABSTRACT

The present invention provides a system and method for testing and certifying one or more aspects of a device, such as a network, telecommunications, or computing device. One or more pre-defined or user-specified tests are identified by a user and applied by a testing entity to an aspect of the device. The results of the test are gathered and compared to one or more pre-determined standards. If the product passes the test, the device is certified by the testing entity and the results are published in an online catalog accessible via the Internet. Additionally, the product vendor is granted a license to use a certification logo in connection with the product. If the product fails the test, a private communication is sent from the testing entity to the product vendor indicating the failure. Any desired test can be applied to one or more aspects of a product, such as Voice-over-IP (VoIP) capabilities and other desired features of the product.

### BACKGROUND OF THE INVENTION

1. Field of the Invention

The present invention relates to methods for testing and certifying products. More particularly, the present invention provides a system and method for testing and certifying products and aspects thereof, including telecommunications and computing devices.

2. Related Art

In numerous industries, it is often desirable to test and certify various aspects of a product. For example, in the computing arts, benchmarking tests are employed for testing the relative performance of selected aspects of a computer system, and serve as a basis for comparing aspects of products produced by numerous manufactures. An example of a benchmarking test is the Dhrystone benchmark, which is a CPU-bound benchmark for determining a system's integer processing performance. The results of this test can be used to objectively compare and rank the relative processing powers of various microprocessors, independent of the manufacturer and internal architecture of a given processor.

In addition to benchmarking, it is also desirable to ascertain the performance characteristics of a device and compare the results to established standards to determine whether the device complies with such standards. For example, in the telecommunications industry, it is often desirable to test the relative speech quality of a Voice-over-IP (VoIP) connection to determine whether the connection is capable of reliably carrying voice traffic. Algorithms such as the Perceptual Evaluation of Speech Quality (PESQ) and Perceptual Speech Quality Management (PSQM) algorithms can be applied to voice traffic to produce an indication of the relative clarity of voice communications over a VoIP connection. The results of the test can then be used to determine whether a subject VoIP connection can be reliably used for voice traffic, or whether further adjustment is necessary to reliably carry such traffic.

It is known in the art to certify a product as being compliant with one or more industry standards. An example is Underwriters Laboratory, which tests various aspects of electrical components and determines the compliance of such products with various electrical safety standards. If a product passes a given test, it may be certified as “UL listed,” and the vendor may then be granted the right to display the “UL” certification logo. However, the testing and certifications granted by UL relate predominantly to product safety, and provide no useful information about a product's performance characteristics and capabilities. Moreover, a particular problem with existing testing and certification methodologies lies in the lack of robustness and flexibility of tests currently performed, and accessibility to testing results by product vendors and the consuming public.

Accordingly, what would be desirable, but has not yet been provided, is a system and method for testing and certifying one or more performance aspects of a device, wherein results of testing can be easily accessed by the public.

### SUMMARY OF THE INVENTION

The present invention relates to a system and method for testing and certifying one or more aspects of a device, such as, but not limited to, a network, telecommunications device, or computing device. One or more pre-defined or user-specified tests are identified by a user and applied by a testing entity to an aspect of the device. The tests can be specified by a user or by a testing entity. The results of the test are gathered and compared to one or more pre-determined standards or claims. If the product passes the test, i.e., the product meets or exceeds the pre-determined standards or claims, the device is certified by the testing entity and the results are published, for example, in an online catalog accessible via the Internet. Additionally, the product vendor is granted a license to use a certification logo in connection with the product. If the product fails the test, a private communication is sent from the testing entity to the product vendor indicating the failure. Any desired test can be applied to one or more aspects of a product.

The present invention further provides a method for allowing a user to test and certify a device. The user submits a product to be tested to a testing entity, and identifies one or more tests to be performed by the testing entity. The testing entity then performs the test. The product vendor receives a communication from the testing entity indicating the results of testing. If the product passes the test, the product vendor can have the results posted in an online catalog accessible via the Internet and can display a certification logo in connection with the product. If the product fails the test, the product vendor can try to improve the product and can re-submit the product for re-testing. After a product has been certified and the results published in the online catalog, additional tests can be specified and performed.

The present invention also provides a system for testing and certifying a device. A web server is provided and hosts a web site for allowing one or more product vendors to specify one or more tests to be performed on the product. A testing entity performs the one or more tests on the product. A certification server is provided in communication with the web server, and includes an online catalog stores testing results for products that have passed the tests. The online catalog includes a certification database for storing certification information and a product database for storing product information. A communications interface connects the web server to a larger network, such as the Internet.

The present invention further provides a method for testing and certifying Voice-over-IP (VoIP) capabilities of a device. The method comprises the steps of connecting the device between two end nodes, establishing a VoIP call between the two end nodes and across the device, testing voice quality of the call using a voice quality tester, comparing tests results to pre-determined standards, certifying the product as having VoIP capability and storing testing results in an on-line catalog if the results meet or exceed the pre-determined standards; and if the results do not meet or exceed the pre-determined standards, communicating a failure to the product vendor. The effects of traffic congestion can be measured, in addition to Quality-of-Service (QoS) capabilities of the device.

### BRIEF DESCRIPTION OF THE DRAWINGS

Other important objects and features of the invention will be apparent from the following Detailed Description of the Invention taken in connection with the accompanying drawings in which:

FIGS. 1 and 2 are flowcharts showing the testing and certification method of the present invention.

FIG. 3 is a diagram showing the testing and certification system of the present invention.

FIGS. 4a-4c are flowcharts showing the testing and certification method of the present invention, wherein Voice-over-IP (VoIP) capability of a telecommunications device is tested and certified.

### DETAILED DESCRIPTION OF THE INVENTION

The present invention relates to a system and method for testing and certifying products, such as telecommunications and computing devices. One or more user-defined or pre-defined tests are selected and applied to an aspect of a product. The tests can be submitted and configured by a product vendor, and parameters of the test can be adjusted by the vendor as desired. Optionally, the product vendor can specify a test. The test is performed, and results of the test are gathered. If the aspect of the product being tested fails the test, the vendor is notified of such failure in a private communication (e.g., by fax, e-mail, or voice communication). If the aspect passes the test, the aspect of the product is certified. The certification, product information, and test results are stored in an on-line catalog and made accessible to the public for a predetermined period of time through a website. The product vendor is granted a license to display a certification logo in connection with the product. Additional tests can be applied to test other aspects of the product, and results of testing and certification made available in the online catalog.

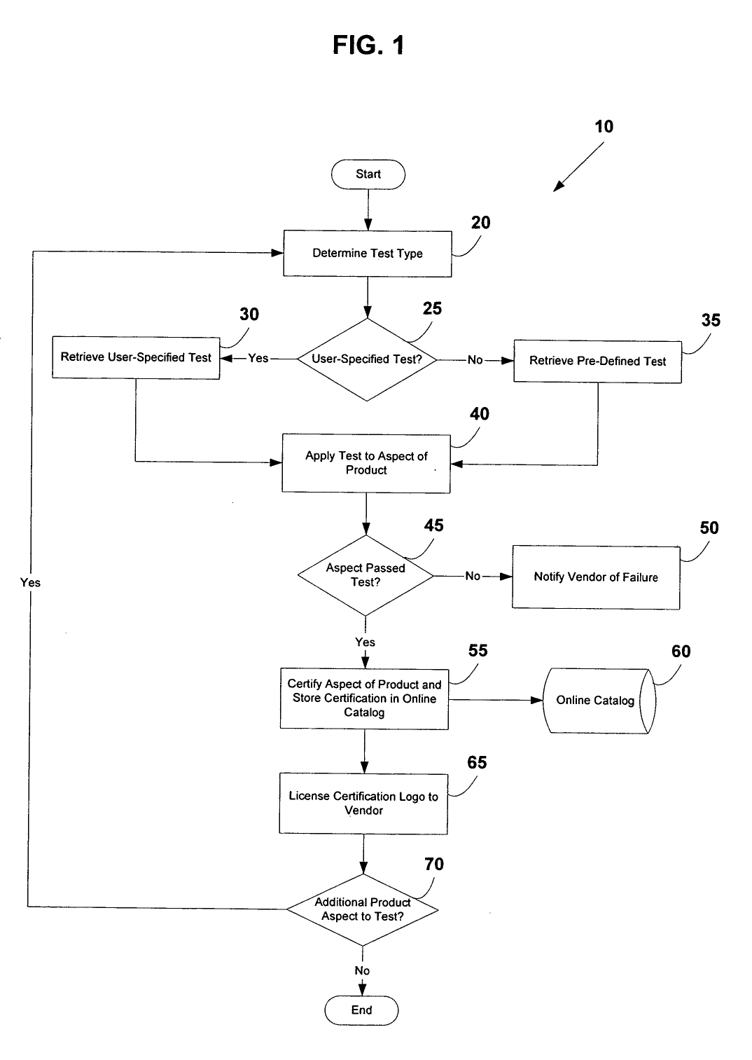

FIG. 1 is a flowchart showing the testing and certification method of the present invention, indicated generally at 10. The method 10 can be applied to any product, or aspect thereof, for which testing and certification is desired. Examples of such products include, but are not limited to, telecommunications devices (e.g., routers, switches, hubs, bridges, modems, caching devices, wireless access points, network cards, cabling, optical devices, multiplexers, or any other similar equipment) and computing devices (e.g., personal computers, personal digital assistants, laptops and notebook computers, embedded computers, controllers, or any other similar equipment). It is to be understood that any aspect of any device can be tested and certified without departing from the spirit or scope of the present invention.

In step 20, a test type to be applied to the product is determined. The test type can vary according to the aspect of the product being tested, and can be applied to determine the product's features, functions, and performance characteristics. For example, if the device is a local area network (LAN) switch, a desired aspect of the switch can be tested, such as application traffic recognition capability, jumbo frame support, rapid reconfiguration spanning tree support, 10/100/1,000 megabits-per-second auto-negotiation capability, link aggregation control, Internet Protocol version 6 (IPv6) wire speeds, auto MDI/MDIX capability, port mirroring, redundant power supply, port access authentication using IEEE 802.1x standard, the presence of dual firmware images, non-destructive upgrade capability, application traffic recognition, data transmission performance, or any other aspect for which testing is desired.

In step 25, a decision is made as to whether the test is a user-specified test. Importantly, the present invention allows both pre-defined and user-specified tests to be applied to one or more aspects of a product. If a positive determination is made, step 30 is performed, and the user-specified test is retrieved. The user-specified test can be configured as desired, and parameters thereof can be adjusted as desired. Of course, a user-specified test can become a pre-defined test that subsequent users can have applied to their products. If a negative determination is made in step 25, step 35 is performed, wherein a pre-determined test is retrieved. The pre-determined test can be previously defined by an entity or individual operating the present invention, a product vendor, or any other user.

In step 40, the test is applied to an aspect of the product. As mentioned earlier, the test could be any test for any aspect of the product, such as automatic traffic recognition capability, VoIP capability, or any other feature, function, or performance characteristic of the device can be tested. After the test has been applied, in step 45, the results of the test are gathered and analyzed to determine whether the aspect passed the test. If a negative determination is made, step 50 is performed, wherein the vendor is notified of a failure. Preferably, the vendor is notified of the failure by way of a private communication between the testing entity and the vendor, such as by facsimile, phone, e-mail, or other suitable communication.

In the event that a positive determination is made in step 45, step 55 is performed, wherein the aspect of the product is certified. For example, the product could be certified as being capable of reliably handing VoIP traffic if the product passes one or more VoIP capability tests, or the product could be certified as having 10/100/1000 mbps auto-switching capability if the device passes an auto-negotiation test. Any conceivable certification can be utilized in step 55. Additionally, in step 55, information about the product, including a description of the product, test results, and certification information, is stored in an on-line catalog 60 for a pre-determined period of time. Preferably, the information is stored for a one-year period, but any desired period of time can be used. The information in the online catalog 60 is accessible to both the public and the product vendor.

In step 65, the vendor is granted a license to use a certification mark in connection with the product, to indicate that the aspect of the product has been tested and is certified. The certification mark could be any desired mark, and can be used in product advertising, promotional literature, packaging, or any other documentation or communication relating to the product. Finally, in step 70, a determination is made as to whether additional aspects of the product are to be tested. If a positive determination is made, step 20 is repeated, so that such additional aspects can be tested and certified, and additional results stored in the on-line catalog. Thus, as can readily be appreciated, the online catalog 60 of the present invention provides a rich repository of information about a product's features, functionality, and capabilities.

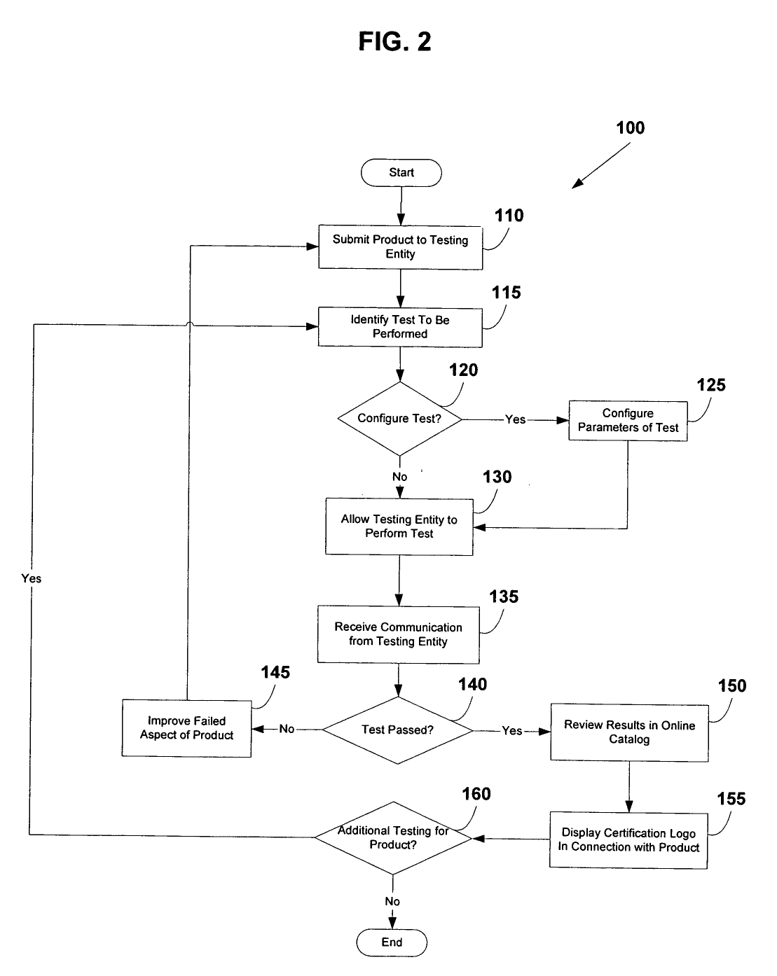

FIG. 2 is a flowchart showing the testing and certification methodology of the present invention, described from the perspective of a product vendor and indicated generally at 100. Beginning in step 110, the product vendor submits a product to be tested and certified to a testing entity. In step 115, the vendor specifies a test to be performed on an aspect of the product. The test can be specified by the vendor using a website provided by the testing entity, or through any other communication. In step 120, a determination is made as to whether the vendor wishes to configure the test. If a positive determination is made, step 125 is performed, wherein the user can configure parameters of the test. Such configuration can be accomplished by any desired means, and preferably, by way of one or more web pages where test parameter information can be entered.

After the test has been configured in step 125, or if a negative determination has been made in step 120, step 130 is performed, wherein the testing entity is allowed to perform the test. Testing could occur at a remote location (i.e., at the facilities of the testing entity), and can occur at a time scheduled by either the product vendor or the testing entity. Conceivably, if the device is connected to a network, the test could occur online and monitored in real time. After the test has been performed, in step 135 the vendor receives a communication from the testing entity, indicating the results of the test. The communication could be in any desired format, such as an e-mail, a fax, or other communication. In step 140, a determination is made as to whether the product passed the test. If a negative determination is made, step 145 is invoked, wherein the vendor can improve the failed aspect of the product. Then, step 110 is repeated, wherein the aspect of the product can be re-tested in accordance with method 100. If a positive determination is made in step 140, step 150 occurs, wherein the vendor can review the results of the test in the online catalog. Then, in step 155, the vendor displays a certification logo in connection with the product. In step 160, a determination is made as to whether an additional aspect of the product should be tested. If so, step 110 is repeated, so that the additional aspect can be tested and certified in accordance with method 100.

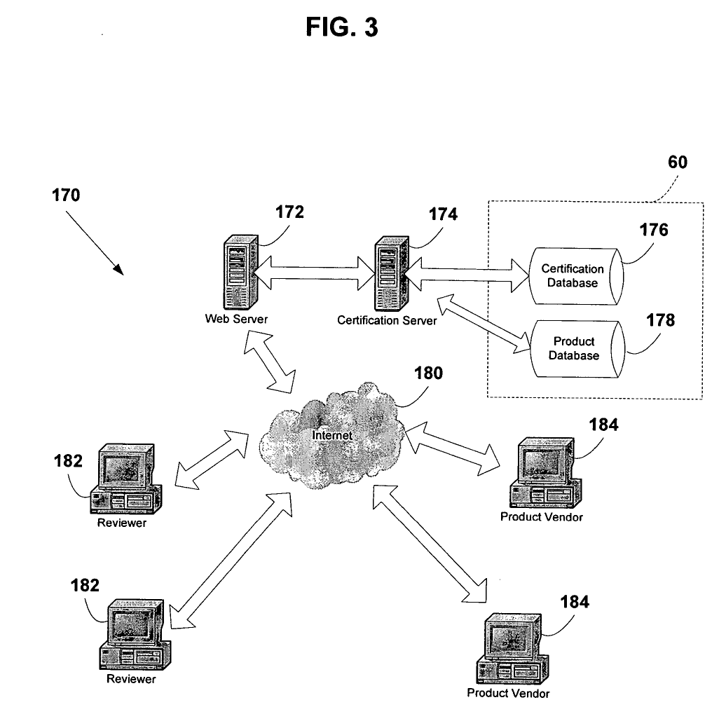

FIG. 3 is a diagram of the testing and certification system of the present invention, indicated generally at 170. The present invention can be implemented on one or more computer systems and preferably through a website associated with a testing entity. For example, a web server 172 and a certification server 174 can be provided at a testing entity's location, and can communicate via the internet 180 with a plurality of reviewer computer systems 182 and one or more product vendor computer systems 184. The web server 172 provides one or more web pages accessible by the product vendor systems 184 for specifying and/or configuring tests to be performed on products. The tests are communicated via the web server 172 to the certification server 174, or alternatively, could be pre-defined tests stored in the certification server 174. The certification server 174 communicates with the online catalog 60 to store product information, test results, and certification information. Such information can be stored in a certification database 176 and a product database 178. The online catalog 60 is accessible by the reviewer computer systems 182 to review product information, test results, and certification information.

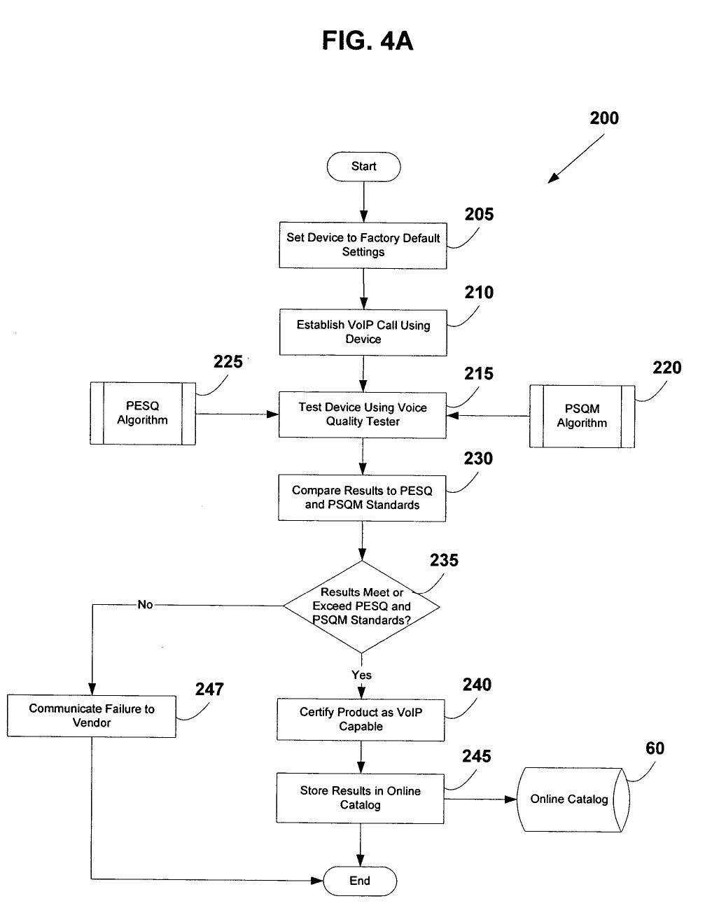

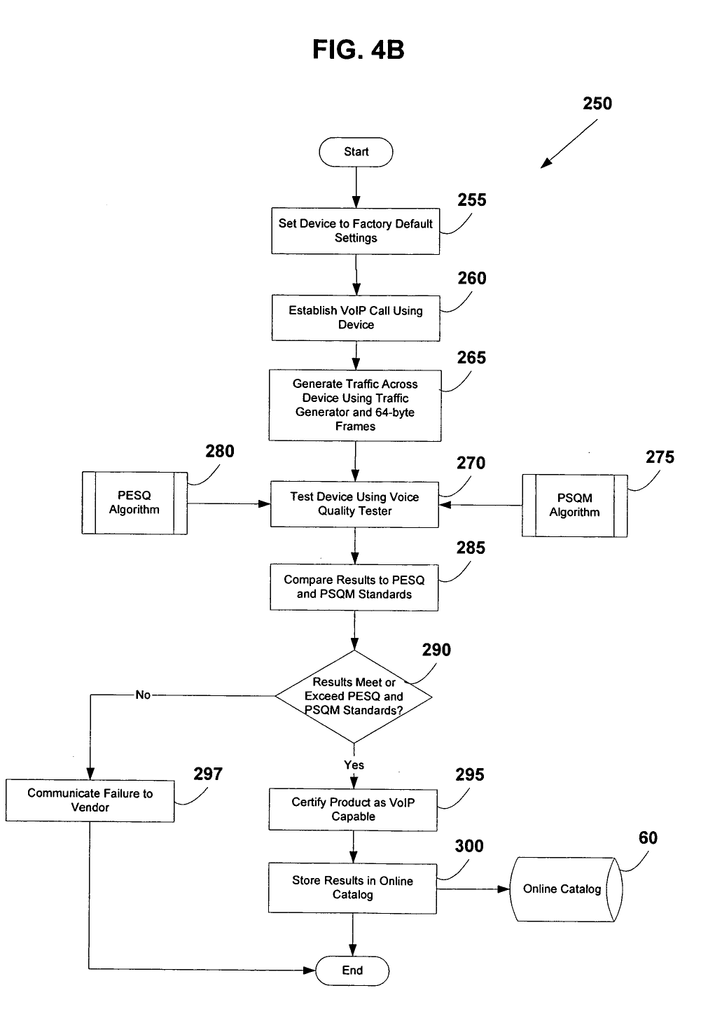

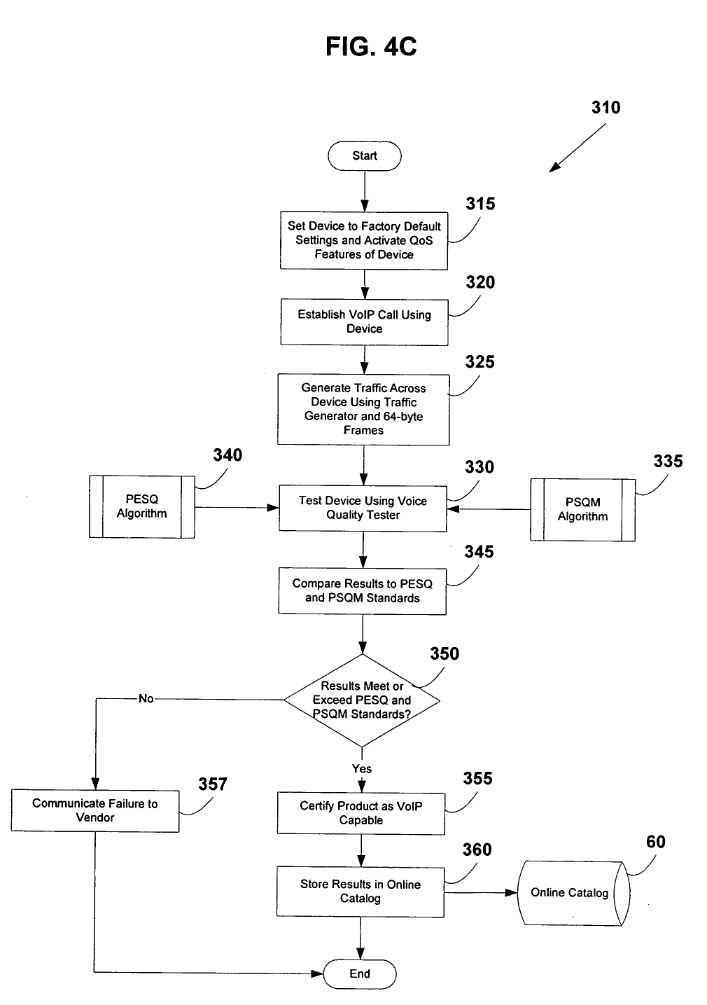

FIGS. 4a-4c are flowcharts showing the testing and certification method of the present invention, wherein Voice-over-IP (VoIP) capability of a telecommunications device is tested and certified.

FIG. 4a is a flowchart showing the method of the present invention, indicated generally at 200, for testing and certifying VoIP capabilities of a device. Beginning in step 205, a network device, such as a switch, router, or hub, is set to factory default settings. Additionally, ancillary features of the device are disabled, such as flow control features and spanning tree features. Then, in step 210, a VoIP call is established between two end nodes and across the device. In step 215, the voice quality of the call is determined using a voice quality tester that preferably utilizes the Perceptual Speech Quality Measurement (PSQM) and Perceptual Evaluation of Speech Quality (PESQ) algorithms 220 and 225, respectively. PSQM, described in International Telecommunications Union ITU-T P.861, is a quality measurement algorithm that tests voice quality through a voice encoder/decoder (codec) by comparing a voice sample after it has passed through the codec to the original sample. PESQ, described in International Telecommunications Union ITU-T P.862, is also a quality measurement algorithm that expands upon PSQM by adding additional processing steps to account for signal-level differences and packet losses. Any suitable voice quality testing algorithm can be used in place of the PESQ and PSQM algorithms without departing from the spirit or scope of the present invention. The voice quality tester utilized in step 215 could be a voice quality tester manufactured by Agilent, Inc., or any other suitable tester.

In step 230, results of testing conducted in step 215 are gathered, and compared to PESQ and PSQM standards for voice quality. The PESQ and PSQM standards are based upon voice quality standards promulgated by the International Telecommunications Union (ITU). Then, in step 235, a determination is made as to whether the results meet or exceed PESQ and PSQM standards. If a positive determination is made, step 240 is invoked, wherein the device is certified as being capable of reliably supporting VoIP traffic. Then, in step 245, the results of testing are stored in the online catalog 60 for a predetermined period of time, e.g., one year. In the event that a negative determination is made in step 235, step 247 is invoked, wherein the product vendor is informed that the results of testing conducted in step 215 did not meet or exceed the PESQ and PSQM standards, and that the product is not certified as being VoIP capable. The product vendor could be informed using any mode of communication, such as by fax, e-mail, or other suitable means.

FIG. 4b is a flowchart showing another method according to the present invention, indicated generally at 250, for testing and certifying VoIP capabilities of a device. The method 250 expands upon the method 200 described earlier and shown in FIG. 4a by testing VoIP capabilities of a device when congestion is introduced into the network. Beginning in step 255, the network device to be tested is set to factory default settings, and ancillary features of the device are disabled, such as flow control features and spanning tree features. Then, in step 260, a VoIP call is established between two end nodes and across the device. In step 265, a traffic generator is connected to all access and core switches between the two nodes, and network congestion is simulated by introducing traffic into the network using 64-byte frames destined for opposite nodes of the network and traversing the device under test. Preferably, all traffic generated is in excess of the traffic capabilities of the interconnect links with the device under test.

In step 270, the voice quality of the call is determined using a voice quality tester the preferably utilizes the PSQM and PESQ algorithms 275 and 280, respectively. However, any suitable voice quality testing algorithm can be used in place of the PESQ and PSQM algorithms without departing from the spirit or scope of the present invention. The voice quality tester utilized in step 270 could be a voice quality tester manufactured by Agilent, Inc., or any other suitable tester. In step 285, results of testing conducted in step 270 are gathered, and compared to PESQ and PSQM standards for voice quality. The PESQ and PSQM standards are based upon voice quality standards promulgated by the International Telecommunications Union (ITU). Then, in step 290, a determination is made as to whether the results meet or exceed PESQ and PSQM standards. If a positive determination is made, step 295 is invoked, wherein the device is certified as being capable of reliably supporting VoIP traffic. Then, in step 300, the results of testing are stored in the online catalog 60 for a predetermined period of time, e.g., one year. In the event that a negative determination is made in step 290, step 297 is invoked, wherein the product vendor is informed that the results of testing conducted in step 270 did not meet or exceed the PESQ and PSQM standards, and that the product is not certified as being VoIP capable. The product vendor could be informed using any mode of communication, such as by fax, e-mail, or other suitable means.

FIG. 4c is a flowchart showing another method according to the present invention, indicated generally at 310, for testing and certifying VoIP capabilities of a device. The method 310 expands upon the method 250 described earlier and shown in FIG. 4b by testing VoIP capabilities of a device when congestion is introduced into the network and quality-of-service (QoS) capabilities of the device are enabled. In step 315, the network device to be tested is set to factory default settings, and ancillary features of the device are disabled, such as flow control features and spanning tree features. Additionally, QoS features of the device are enabled. In step 320, a VoIP call is established between two end nodes and across the device. Then, in step 325, a traffic generator is connected to all access and core switches between the two nodes, and network congestion is simulated by introducing traffic into the network using 64-byte frames destined for opposite nodes of the network and traversing the device under test. Preferably, all traffic generated is in excess of the traffic capabilities of the interconnect links with the device under test.

In step 330, the voice quality of the call is determined using a voice quality tester the preferably utilizes the PSQM and PESQ algorithms 335 and 340, respectively. However, any suitable voice quality testing algorithm can be used in place of the PESQ and PSQM algorithms without departing from the spirit or scope of the present invention. The voice quality tester utilized in step 330 could be a voice quality tester manufactured by Agilent, Inc., or any other suitable tester. In step 345, results of testing conducted in step 330 are gathered, and compared to PESQ and PSQM standards for voice quality. The PESQ and PSQM standards are based upon voice quality standards promulgated by the International Telecommunications Union (ITU). Then, in step 350, a determination is made as to whether the results meet or exceed PESQ and PSQM standards. If a positive determination is made, step 355 is invoked, wherein the device is certified as being capable of reliably supporting VoIP traffic. Then, in step 360, the results of testing are stored in the online catalog 60 for a predetermined period of time, e.g., one year. In the event that a negative determination is made in step 350, step 357 is invoked, wherein the product vendor is informed that the results of testing conducted in step 330 fell below the PESQ and PSQM standards, and that the product is not certified as being VoIP capable. The product vendor could be informed using any mode of communication, such as by fax, e-mail, or other suitable means.

As mentioned earlier, the present invention can be practiced using any known or future-developed test for testing and/or certifying any desired aspect of any product. An online catalog of these tests is provided for users to review and choose from for application to their products. Table 1 lists and describes examples of tests that can be utilized with the present invention. The tests listed therein are illustrative in nature, and could be expanded to include any desired or future-developed test:

TABLE 1

| Test Name | Description |
|---|---|
| VoIP Capable Infrastructure (Quality of Service) | This certification verifies that the device under test's |
| | QoS mechanisms can adequately support latency |
| | sensitive applications such as voice in a congested |
| | environment by providing sufficiently low latency as |
| | well as voice quality scores that are coincident with |
| | those deemed toll quality. |
| Non-Destructive Code Upgrade | This certification verifies that the device under test's |
| | firmware can be upgraded without erasing the device |
| | configuration settings. |
| Jumbo Frame Support - 9K | This certification verifies that the device under test can |
| | transport so-called Ethernet “Jumbo Frames” up to |
| | 9,000 bytes. This is a layer 2 test and assumes that |
| | the Ethernet frame is transported end-to-end as a |
| | single unit and is not fragmented. |
| Gigabit Ethernet Wire Speed Capture | This certification verifies that the device under test can |
| | capture data at the rate of 1 Gigabit per second |
| | without loss |
| Fast Ethernet Wire Speed Capture | This certification verifies that the device under test can |
| | capture data at the rate of 100 Megabits per second |
| | without loss |
| Gigabit Ethernet No Loss Tap | This certification verifies that the device under test |
| | provides an error-free “tap” of a Gigabit Ethernet |
| | connection. |
| Rapid Reconfiguration Spanning Tree Support | This certification verifies that the device under test can |
| (802.1w) | reconfigure its layer 2 spanning tree using the IEEE |
| | 802.1w “rapid” option. |
| 10/100 Auto-negotiation | This certification verifies that the device under test |
| | responds properly to various speed and duplex mode |
| | settings from a variety of 10/100 Ethernet network |
| | interface cards and/or LAN switches as appropriate. |
| Switch QoS - Maintains Voice Quality under Load | This certification verifies that a VoIP telephone can |
| | appropriately recognize and prioritize traffic based on |
| | 802.1p (L2) or DiffServ (L3 IP) QoS mechanisms. |
| 802.1p QoS Tagging | This certification verifies a device's ability to tag |
| | generated voice traffic with the appropriate 802.1p |
| | QoS tag. |
| Link Aggregation (IEEE 802.3ad) | This certification verifies that the device implements |
| | standards-based Link Aggregation and can create a |
| | single logical switch-to-switch link from two or more |
| | physical switch ports. |
| IPV6 Wire Speed 48-port Fast Ethernet | IPV6 Wire Speed 48-port Fast Ethernet |
| 10/100/1000 Auto-Negotiation | This certification verifies that the device under test |
| | responds properly to various speed and duplex mode |
| | settings from a variety of 10/100/1000 Ethernet |
| | network interface cards and/or LAN switches as |
| | appropriate. |
| Auto MDI/MDIX | This certification verifies that the device under test can |
| | automatically recognize the presence of a straight- |
| | through or crossover cable and adjust its port setting |
| | accordingly |
| Port Mirroring | This certification verifies that the device under test can |
| | duplicate the traffic associated with a given port to |
| | another port on the device under test. |
| Redundant Power Supply | This certification verifies the presence of an integrated |
| | redundant power supply functionality in the device |
| | under test. |
| Port Access Authentication via 802.1x | This certification verifies that the device under test can |
| | successfully provide port validation to a RADIUS |
| | server using the IEEE 802.1x authentication |
| | protocol. NOTE: This certification has |
| | been superceded by 10559 which is not product- |
| | specific. All future 802.1x certifications will use |
| | 10559. |
| Dual firmware images | This certification verifies that the device can store two |
| | firmware images from which to load the system |
| | software (as distinct from the customer configuration) |
| | for the device. |
| Dual configuration images | This certification verifies that the device can store two |
| | images from which to load the customer configuration |
| | (as distinct from the system software) for the device. |
| Wake on LAN (WoL) | This certification verifies that the device can |
| | successfully respond to a Wake on LAN request and |
| | initiate a power-on/boot up of the host PC. |
| Wake on Magic Packet ™ | This certification verifies that the device can |
| | successfully respond to a “Magic Packet” request and |
| | initiate a power-on/boot up of the host device. |
| Auto MDI/MDIX | This certification verifies that the device under test can |
| | sense and automatically reverse transmit and receive |
| | connections when connected to a switch with the |
| | incorrect cable.. |
| Application Traffic Recognition - KaZaa | This certification verifies that the device under test can |
| | detect and differentiate the specific traffic stream. |
| Application Traffic Recognition - Groove | This certification verifies that the device under test can |
| | detect and differentiate the specific traffic stream. |
| Application Traffic Recognition - XoLox | This certification verifies that the device under test can |
| | detect and differentiate the specific traffic stream. |
| Save/Load Configuration to Text File | This certification verifies that the device under test |
| | provides a management function that allows the device |
| | configuration to be saved to or loaded from a |
| | text/image file. |
| Save/Load Configuration to XML File | This certification verifies that the device under test |
| | provides a management function that allows the device |
| | configuration to be saved to or loaded from a text file |
| | that is formatted using the Extensible Markup Language |
| | (XML). |
| Layer 2 Wire Speed Fast Ethernet - All Ports (Fixed | This certification verifies the backplane capacity of the |
| Configuration Switch) | switch. Specifically, that it can deliver wire-speed |
| | throughput for all common frame sizes with all ports |
| | active. |
| Access Control List (ACL) Functionality Bound to | This certification verifies that the device under test can |
| Specified VLAN | be configured with individual ACLs bound to separate |
| | VLANs. |
| Rollback to last good configuration | This certification verifies that the device under test |
| | provides a management function that allows the |
| | system configuration to be restored to a previous |
| | working configuration without requiring a manual |
| | “restore” of a previous configuration backup file. |
| PXE 2.0 | This certification verifies that the device under test |
| | provides support for the Pre-Execution boot |
| | environment. |
| VLAN Support (IEEE 802.1Q) | This certification verifies a devices ability to |
| | appropriately tag and distinguish traffic between |
| | multiple VLANs. |
| QoS Recognition (IEEE 802.1p) | This certification verifies a devices ability to distinguish |
| | and prioritize traffic based on the 802.1p Quality of |
| | Service standards. |
| Rate Limiting Per Port | This certification verifies that a device under test can |
| | effectively limit the transmission rate on a single given |
| | interface. |
| Management Access Authentication via IP Access | This certification verifies that the device under test |
| Control Lists | provides functionality that allows network mangers to |
| | limit management access to host computers that use |
| | specific TCP/IP addresses. |
| Management Access Authentication via RADIUS | This certification verifies that the device under test |
| | provides functionality that allows network mangers to |
| | limit management access to users that complete |
| | authentication with a backend RADIUS server with |
| | which the device under test communicates. |
| Port Access Authorization via MAC Address | This certification verifies that the device under test |
| | provides functionality that allows network managers to |
| | limit client port access to stations that have specific |
| | layer 2 MAC addresses. |
| IPv4 Forwarding Benchmark | Official IP V4 forwarding benchmarking of the NPF |
| MPLS Forwarding Benchmark | Official MPLS benchmark of the NPF |
| IPv6 Forwarding Benchmark | Official IP V6 forwarding benchmark of the NP Forum. |
| ‘LinleyBench 2002’ - Core | Core benchmarking criteria set down by The Linley |
| | Group |
| 'LinleyBench 2002' - Optional | Optional benchmarks defined by The Linley Group |
| IPV4 (L3) Wire Speed Fast Ethernet - All Ports (Fixed | This certification verifies the backplane capacity of the |
| Configuration Switch) | switch. Specifically, that it can deliver wire-speed |
| | throughput for all common frame sizes with all ports |
| | active. |
| 40 Bit WEP Capable | This certification verifies that the device under test |
| | successfully communicates with partner devices using |
| | this specific Wired-Equivalency Privacy (WEP) |
| | encryption key length. |
| 128 Bit WEP Capable | This certification verifies that the device under test |
| | successfully communicates with partner devices using |
| | this specific Wired-Equivalency Privacy (WEP) |
| | encryption key length. |
| 256 Bit WEP Capable | This certification verifies that the device under test |
| | successfully communicates with partner devices using |
| | this specific Wired-Equivalency Privacy (WEP) |
| | encryption key length. |
| ASCII WEP Key Configurable | This certification verifies that the device under test |
| | allows the WEP key to be configured using ASCII (text) |
| | characters. |
| HEX WEP Key Configurable | This certification verifies that the device under test |
| | allows the WEP key to be configured using HEX |
| | characters. |
| DHCP Server Capable | This certification verifies that the device under test |
| | implements a basic Distributed Host Control Protocol |
| | (DHCP) server and can provide TCP/IP addresses to its |
| | wireless clients. |
| 802.11b+ Turbo mode support | This certification verifies a devices support for |
| | 802.11b+ turbo modes for a wireless network. |
| Bi-polar Antenna Configurable | This certification verifies that the device supports and |
| | utilizes bi-polar antenna configuration. |
| Layer 2 Wire Speed Fast Ethernet with L3 ACLs - All | This certification verifies that the switch can forward |
| Ports (Fixed Configuration Switch) | traffic at wire-speed while applying a L3 IPv4-based |
| | access control lists on all ports. |
| IPV4 (L3) Wire Speed Gigabit Ethernet - All Ports (Fixed | This certification verifies the backplane capacity of the |
| Configuration Switch) | switch. Specifically, that it can deliver wire-speed |
| | throughput for all common frame sizes with all ports |
| | active. |
| Layer 2 Wire Speed Gigabit Ethernet - All Ports (Fixed | This certification verifies the backplane capacity of the |
| Configuration Switch) | switch. Specifically, that it can deliver wire-speed |
| | throughput for all common frame sizes with all ports |
| | active. |
| System Upgrade via Trivial File Transfer Program (TFTP) | This certification verifies that system under test |
| | supports upgrading of system software and/or |
| | firmware via TFTP. |
| Latency Resolution | Latency Resolution |
| Stand Alone Testing Platform | This certification verifies that the device under test can |
| | function as without the need for another device |
| | (usually a PC) to control the device under test. |
| Remote Control Capable Testing Platform - Integrated | This certification verifies that the device under test can |
| Fast Ethernet | be controlled remotely over TCP/IP - Ethernet LAN. |
| User Authentication via IEEE 802.1X | This certification verifies that a device is capable of |
| | implementing 802.1X (EAP) protocol to authenticate a |
| | client station. |
| True10-160 Gigabits L2 Throughput | This certification verifies the backplane capacity of the |
| | switch. Specifically, that it can deliver a full 20 Gigabits |
| | per second (full duplex) for each 10Gigabit Ethernet |
| | interface. Aggregate device throughput is |
| | 160 Gigabit/s per second sustained. |
| True10-320 Gigabits L2 Throughput | This certification verifies the backplane capacity of the |
| | switch. Specifically, that it can deliver a full 20 Gigabits |
| | per second (full duplex) for each 10Gigabit Ethernet |
| | interface. Aggregate device throughput is |
| | 160 Gigabit/s per second sustained. |
| True10-160 Gigabits IP V4 (L3) Throughput | This certification verifies the backplane capacity of the |
| | switch. Specifically, that it can deliver a full 20 Gigabits |
| | per second (full duplex) for each 10Gigabit Ethernet |
| | interface. Aggregate device throughput is |
| | 160 Gigabit/s per second sustained. |
| True10-320 Gigabits IP V4 (L3) Throughput | This certification verifies the backplane capacity of the |
| | switch. Specifically, that it can deliver a full 20 Gigabits |
| | per second (full duplex) for each 10Gigabit Ethernet |
| | interface. Aggregate device throughput is |
| | 320 Gigabit/s per second sustained. |
| Virtual Router Redundancy Protocol (VRRP) | This certification verifies the device under test |
| | implements the VRRP backup router function. |
| Transparent Definition/Library/Signature Updates | This certification verifies that the device under test can |
| | update its definition files without adversely affecting |
| | the normal operation of the DUT. |
| High Availability Failover - Allow All | This certification verifies that the if the device under |
| | test has a software failure, it can revert to allowing all |
| | traffic to traverse the DUT. |
| High Availability Failover - Allow None | This certification verifies that if the device under test |
| | has a software failure, it can revert to blocking all |
| | traffic. |
| Redundant Fabric Module | This certification verifies that the device supports |
| | redundant failover across the switching fabric and can |
| | restore traffic flows within several seconds. |
| User Authentication via local MAC Address Table | This certification verifies that a device is capable of |
| | authorizing clients access via a local MAC table. |
| User Authentication via Local User Database | This certification verifies that a device is capable of |
| | authorizing clients via a local database of user names |
| | and passwords. |
| User Authentication via RADIUS Server | This certification verifies that a device is capable of |
| | authorizing clients via a remote RADIUS server. |
| Embedded Web Management | This certification verifies a device provides |
| | comprehensive web management. |
| Power Over Ethernet Support | This certification verifies a device ability to be powered |
| | with standard PoE (802.3af). |
| Cisco Fast EtherChannel support | This certification verifies a devices ability to |
| | appropriately interoperate with Cisco Systems Fast |
| | EtherChannel trunking protocol. |
| Secure Shell (SSH) remote access | This certification verifies a devices ability to encrypt |
| | management traffic from remote locations. |
| Fast Ethernet Wire Speed Traffic Generation | This certification verifies that the device under test can |
| | generate line rate traffic. |
| Gigabit Ethernet Wire Speed Traffic Generation | This certification verifies that the device under test can |
| | generate line rate traffic. |
| 10 Gigabit Ethernet Wire Speed Traffic Generation | This certification verifies that the device under test can |
| | generate line rate traffic. |
| 802.1Q VLAN Tagging | This certification verifies a device's ability to tag |
| | generated voice traffic with the appropriate VLAN tag. |
| Diffserv QoS Tagging | This certification verifies a device's ability to tag |
| | generated voice traffic with the appropriate Diffserv |
| | QoS tag. |
| Integrated Wire Speed Switching | This certification verifies a device's ability to forward |
| | traffic at line rate. |
| IPV4 (L3) Wire Speed 128-port Gigabit Ethernet | This certification verifies the backplane capacity of the |
| | switch. Specifically, that it can deliver wire-speed |
| | throughput for all common frame sizes with all ports |
| | active. |
| User authentication via Layer 3 (IP) based Access | This certification verifies that a device is capable of |
| Control List | authorizing clients access using local ACLs via Layer |
| | 3 IP addresses. |
| User authentication via Layer 4 (TCP/UDP) based | This certification verifies that a device is capable of |
| Access Control List | authorizing clients access using local ACLs via Layer |
| | 4 TCP/UDP ports. |
| QoS - Four Traffic Queues | This certification verifies that a device is capable of |
| | segmenting QoS traffic into four unique and separate |
| | priority queues. |
| QoS - Six Traffic Queues | This certification verifies that a device is capable of |
| | segmenting QoS traffic into six unique and separate |
| | priority queues. |
| QoS - Eight Traffic Queues | This certification verifies that a device is capable of |
| | segmenting QoS traffic into eight unique and separate |
| | priority queues. |
| Layer 2 Wire Speed 128-port Gigabit Ethernet | This certification verifies the backplane capacity of the |
| | switch. Specifically, that it can deliver wire-speed |
| | throughput for all common frame sizes with all ports |
| | active. |
| Call Forwarding | This certification verifies a VoIP telephone can forward |
| | calls unconditionally, on no answer, and on a busy |
| | signal. |
| User Configurable TCP/UDP Operational Ports | This certification verifies a VoIP telephone can be |
| | configured using selected UDP/TCP ports. |
| Remote Administration | This certification verifies a VoIP telephone can be |
| | remotely administered. |
| Incoming and Outbound Call logging | This certification verifies a VoIP telephone can log |
| | incoming and outgoing calls locally. |
| User Configurable CODEC | This certification verifies a VoIP telephone can allow |
| | the user to select between multiple CODECs. |
| Redundant Power Supply - Hot-Swappable | This certification verifies that a device can be powered |
| | by uninterruptible hot-swappable redundant power |
| | supplies. |
| Hot-Swappable Fan | This certification verifies that a device has integrated |
| | cooling fans that may be interchanged without |
| | adversely affecting device operations. |
| Fast Ethernet Wire Speed Monitoring | This certification verifies that the device under test can |
| | monitor data at the rate of 100 Megabits per second |
| | without loss |
| Gigabit Ethernet Wire Speed Monitoring | This certification verifies that the device under test can |
| | monitor data at the rate of 1 Gigabit per second |
| | without loss |
| 1 Connection Allow All Wire Speed Throughput NAT | This certification verifies that a firewall device can |
| Enabled | forward a single connections traffic at wire speed |
| | when allowing all traffic. |
| 1,000 Connections Allow All Wire Speed Throughput | This certification verifies that a firewall device can |
| NAT Enabled | forward 1,000 connections traffic at wire speed when |
| | allowing all traffic. |
| Auto Negotiation | This verifies a device's ability to establish the highest |
| | available speed and duplex settings across multiple |
| | vendor combinations. |
| 802.1p/Q VLAN Tag Propagation | This verifies that the device can properly identify and |
| | propagate frames carrying IEEE 802.1p/Q VLAN tags |
| | with priority bits set. |
| Link Aggregation 802.3ad | This verifies a device's ability to trunk ports across |
| | multiple vendor combinations using LACP and/or MLT. |
| Accelerated Convergence Spanning Tree 802.1w | This verifies a device's ability to converge a layer 2 |
| | bridged network using the IEEE 802.1w protocol with |
| | multiple vendor combinations |
| Gigabit Uplink Support | This verifies a device's ability to interoperate with |
| | multiple vendors gigabit uplinks. |
| IPv4 - RIP v1 - Routing Protocol Support | This verifies that the switches exchange IPv4 routing |
| | table information via RIP. |
| IPv4 - RIP v2 - Routing Protocol Support | This verifies that the switches exchange IPv4 routing |
| | table information via RIP 2. |
| IPv4 - OSPF - Routing Protocols Support | This verifies that the switches exchange IPv4 routing |
| | table information via OSPF. |
| IPv4 - BGP 4 - Routing Protocols | This verifies that the switches exchange IPv4 routing |
| | table information via BGP-4. |
| IPX Routing - Routing Protocol Support | This verifies that the device can participate in an IPX |
| | routed network with multiple vendors' switches. |
| DVMRP - IP Multicasting | This verifies a device's ability to host and join IP |
| | multicast groups via DVMRP in a multi-vendor network. |
| PIM SM - IP Multicasting | This verifies a device's ability to host and join IP |
| | multicast groups via PIM SM in a multi-vendor network.. |
| PIM DM - IP Multicasting | This verifies a devices ability to host and join IP |
| | multicast groups via PIM DM in a multi-vendor network. |
| Virtual Router Redundancy Protocol (VRRP) | This verifies a device's ability to act as a standby |
| | router in the event of failure using VRRP standards in a |
| | multi-vendor network. |
| Jumbo Frame Support | This verifies a device's ability to forward a frame of |
| | 9000 bytes in a multi-vendor environment. |
| 10 Gigabit LAN Phy Support | This verifies a devices ability to transmit data between |
| | multiple vendors 10 Gigabit interfaces. |
| 10 Gigabit WAN Phy Support | This verifies a devices ability to transmit data between |
| | multiple vendors 10 Gigabit interfaces. |
| Split Multi-Link Trunking (Nortel) | This certification verifies that the device under test |
| | supports the aggregation of multiple ports and failover |
| | using Nortel's “SMLT” protocol. |
| 1 Gigabit Fibre Channel Transport | This certification verifies that the device under test can |
| | transparently transport Fibre Channel traffic at the full |
| | line rate of 1 Gbps. Supports transport of 100-SM-LL-L |
| | (Fibre Channel at 1.0625 Gbit/s over single mode fiber |
| | at 1310 nm) at the physical layer per ANSI |
| | X3.230.1994. |
| 2 Gigabit Fibre Channel Transport | This certification verifies that the device under test can |
| | transparently transport Fibre Channel traffic at the full |
| | line rate of 2 Gbps. Supports transport of 200-SM-LC-L |
| | (Fibre Channel at 2.125 Gbit/s over single mode fiber at |
| | 1310 nm) at the physical layer per ANSI INCITS 352.. |
| 1 Gigabit FICON Transport | This certification verifies that the device under test can |
| | transparently transport FICON traffic at the full line |
| | rate of 1 Gbps. FICON is IBM's Fibre Channel |
| | Connection which uses 1 Gigabit Fibre Channel. |
| | Supports transport of 100-SM-LL-L (Fibre Channel at |
| | 1.0625 Gbit/s over single mode fiber at 1310 nm) at the |
| | physical layer per ANSI X3.230.1994 and IBM |
| | document number SA24-7172. |
| ESCON Channel Transport | This certification verifies that the device under test can |
| | transparently transport ESCON traffic at the full line |
| | rate of 200 Mbps. ESCON is IBM's Enterprise System |
| | Connection) per IBM document number SA22-7202 and |
| | SA23-0394. |
| Optical Module Auto-detect | This certification verifies that the device under test can |
| | correctly detect the presence of a newly installed |
| | optical module. |
| Non-disruptive Network Expansion | This certification verifies that the device under test can |
| | be inserted into a network of similar devices and |
| | brought online without disrupting the traffic flow in that |
| | network. |
| Optical Path Redundancy Scheme | This certification verifies that the device under test |
| | implements a UPSR-like, 1:1 optical redundancy |
| | scheme. |
| 1 Gigabit Ethernet Multimode Fiber Transport | This certification verifies that the device under test can |
| | transparently transport Gigabit Ethernet traffic at the |
| | full line rate of 1 Gbps. Supports transport in |
| | compliance with IEEE 802.3Z, SX GE Multimode |
| | (850 nm). |
| 1 Gigabit Ethernet Singlemode Fiber Transport | This certification verifies that the device under test can |
| | transparently transport Gigabit Ethernet traffic at the |
| | full line rate of 1 Gbps. Supports transport in |
| | compliance with IEEE 802.3Z, SX GE Singlemode |
| | (1310 nm) |
| Non-Disruptive (“Hitless”) Code Upgrade | This certification verifies that the device under test's |
| | firmware can be upgraded while the device is running |
| | and “under load”. |
| Management Control Module Redundancy | This certification verifies that the device under test |
| | implements a fully redundant management control |
| | architecture including redundant system configuration |
| | and LAN management port. |
| A/B Power Sources | This certification verifies that the device under test |
| | implements dual power sources to any and all of its |
| | power supplies. |
| Wake On - Link Speed | This certification verifies that the device under test |
| | allows the link speed used on “wake up” to be |
| | configured.. |
| Windows 2000 OS - Host Interrupt Coalescence | This certification verifies that the device under test |
| | offers host interrupt coalescence for inbound traffic |
| | thus reducing the load on the host CPU. |
| Windows 2000 OS - Link Aggregation (802.3ad) | This certification verifies that the device under test |
| | offers standards compatible link aggregation |
| | functionality as specified in IEEE spec 802.3ad |
| Windows 2000 OS - IEEE 802.1Q/p VLAN/Priority | This certification verifies that the device under test |
| Tagging | supports VLAN and priority/Quality-of-service tagging |
| | at layer 2 as specified by the IEEE 802.1Q/p working |
| | groups. |
| Windows 2000 OS - Jumbo Frame Support - 16,000 | This certification verifies that a device under test can |
| bytes | generate and forward frames of approximately 16,000 |
| | bytes. |
| Windows 2000 OS - Jumbo Frame Support - 9,000 | This certification verifies that a device under test can |
| bytes | generate and forward frames of approximately 9,000 |
| | bytes. |
| Embedded Web Management via Secure Sockets | This certification verifies a device provides |
| Layer (SSL) or Transport Layer Security (TLS) | comprehensive web management via SSL and/or TLS |
| | encryption. |
| Power over Ethernet Provider/Recipient | This certification verifies that the WLAN Switch and |
| | radio under test can provide/receive electrical power |
| | as per the IEEE 802.3af |
| Power over Ethernet Provider | This certification verifies that the device under test |
| | can provide electrical power as per the IEEE 802.3af |
| SNMPv3: Management via Encrypted Packets | This certification verifies that the device under test |
| | supports the SNMP v3 encrypted User Security Model |
| Access Point to WLAN Switch Connectivity via an L2 | This certification verifies that the WLAN switch and |
| Switched Network | access point pair under test can communicate across |
| | an industry-standard L2 switched network. |
| Access Point to WLAN Switch Connectivity via an IPv4 | This certification verifies that the WLAN switch and |
| (L3) Network | access point pair under test can communicate across |
| | an IP subnet boundary. |
| Wi-Fi Protected Access (WPA) | This certification verifies that the WLAN switch and |
| | access point pair under test can interact with a back- |
| | end, EAP-enabled RADIUS server to provide WPA |
| | encryption to wireless client stations. |
| Open-system authentication (IEEE 802.11b) | This certification verifies that the WLAN switch or |
| | Access Point supports clear text transfer of wireless |
| | data. |
| Multiple ESS support | This certification verifies that the WLAN switch |
| | supports more than one ESS per WLAN switch. |
| Different MAC Access Control List (ACL) per SSID | This certification verifies that the WLAN switch |
| | supports a different MAC ACL per SSID. |
| Windows 2000 OS - “Vital Signs” | This certification verifies that the device under test |
| | provides a utility program that displays key information |
| | such as MAC address, assigned IP address, link |
| | status, driver and bus information. |
| Windows 2000 OS - Chip-level Diagnostics | This certification verifies that the device under test |
| | provides a utility program that runs chip-level |
| | diagnostics such as MAC and PHY loopbacks, register, |
| | interrupt and EEProm checks. |
| Windows 2000 OS - Cable Analyzer | This certification verifies that the device under test |
| | provides a physical layer cable analysis function. |
| Windows 2000 OS - Identify NIC via LED | This certification verifies that the device under test |
| | provides the capability of triggering an LED to identify |
| | the NIC. |
| Windows 2000 OS - MAC Layer (L2) Station Loopback | This certification verifies that device under test |
| | provides a facility for testing connectivity across the |
| | LAN to another L2 station on the same LAN. |
| Windows 2000 OS - IP Layer (L3) Station Loopback | This certification verifies that device under test |
| | provides a facility for testing connectivity across the |
| | LAN and/or routed network to another IP station. |
| Windows 2000 OS - Configurable Auto-Negotiation | This certification verifies that the device under test |
| Options | provides for granular configuration of acceptable |
| | “negotiated” link speed and duplex settings. |
| Windows 2000 OS - Adapter-specific Event Log | This certification verifies that the device under test |
| | implements its own “event log” providing details about |
| | the adapter like change in state from offline to online. |
| Windows 2000 OS - IEEE 802.3x Ethernet (L2) Flow | This certification verifies that the device under test |
| Control | implements Ethernet (L2) “hop-by-hop” flow control. |
| Windows 2000 OS - TCP/UDP Checksum Offload | This certification verifies that the device under test can |
| | successfully offload the “checksum” (I.e. cyclical |
| | redundancy check) calculations from the host OS. |
| Windows 2000 OS - TCP Segmentation Offload | This certification verifies that the device under test |
| | implements offload of the TCP segmentation function |
| | from the host OS to the NIC. |
| SIP Proxy Server | This certification verifies that the system under test |
| | provides the “Proxy” functionality defined in IETF RFC |
| | 2543. |
| SIP Registrar Server | This certification verifies that the system under test |
| | provides the “Registrar” functionality defined in IETF |
| | RFC 2543. |
| SIP Traffic to Private IP Address Space via Network | This certification verifies that the system under test |
| Address Translation (NAT) and/or Port Address | can map all appropriate SIP ports and addresses to |
| Translation (PAT) | allow SIP clients to communicate from a private |
| | address space to a “foreign” IP subnet. |
| Identify Access Point in “Unconfigured” State | This certification verifies that system under test can |
| | identify the presence of a wireless AP that is powered |
| | on but has not been given a custom configuration. |
| Identify Access Point with Wired Equivalent Privacy | This certification verifies that the system under test |
| (WEP) Disabled | can identify the presence of a wireless AP that has |
| | been configured with the Wired Equivalent Privacy |
| | (WEP) encryption option disabled. |
| Identify Access Point Broadcasting Service Set | This certification verifies that the system under test |
| Identifier (SSID) | can identify the presence of a wireless AP that is |
| | broadcasting its “network name” in clear text. |
| Identify Wireless Client with Wired Equivalent Privacy | This certification verifies that the system under test |
| (WEP) Encryption Disabled | can identify the presence of a wireless client that is |
| | configured with WEP (encryption) disabled. |
| Identify Wireless “ad-hoc” Mode Stations | This certification verifies that the system under test |
| | can detect and identify the presence of wireless |
| | clients running in “ad-hoc” mode. That is, clients that |
| | communicate without relaying traffic through a - |
| | wireless Access Point. |
| Manage “Approved Sender” List (Whitelist) by email | This certification verifies that system under test |
| domain name | provides for manual, “pre-approval” of all e-mail |
| | messages emanating from a specific email domain. |
| Manage “Approved Sender” List (Whitelist) by | This certification verifies that system under test |
| individual email name | provides for manual, “pre-approval” of all e-mail |
| | messages emanating from a specific email address. |
| Basic Challenge/Response: False Positive Prevention | This certification verifies that the system under test |
| | implements a “challenge/response” method whereby all |
| | emails from unknown senders are sent a challenge |
| | email that requests a human-generated response. |
| Unchallenged Recipient Alias (AKA “tracker”) | This certification verifies that the sytem under test |
| | allows users to set up “alias” names for their |
| | accounts. Messages from senders that use these alias |
| | as “TO” names are routed directly to the INBOX. |
| Manage “Blocked Sender” List (Blocklist) by individual | This certification verifies that system under test |
| email name | provides for manual blocking of all e-mail messages |
| | emanating from a specific email address. |
| Manage “Blocked Sender” List (Blocklist) by email | This certification verifies that system under test |
| domain name | provides for manual blocking of all e-mail messages |
| | emanating from a specific email domain name. |
| Customizable “Challenge” Message | This certification verifies that the system under tests |
| | provides a way for the end-user or end-user |
| | organization, as appropriate, to customize the |
| | “challenge” message that is sent to in reply to email |
| | messages from unknown senders. |
| Automatic “Safe-Sender” Status | This certification verifies that the system can apply a |
| | single-sender's “approved” status across multiple |
| | recipients. |
| Manage “Quarantine” Folder auto-delete Time Periods | This certification verifies that the system under test |
| | allows the end-user to adjust the time that a “pending” |
| | message is allowed to remain without a response |
| | before it is automatically deleted. |
| Manage “Challenge” Resend Frequency and Quantity | This certification verifies that the system under test |
| | allows the user to customize how frequently and how |
| | many times an unanswered challenge will be |
| | automatically resent. |
| Transparent Support of “Forwarded Accounts” | This certification verifies that the system under test |
| | can process email from forwarded accounts as well |
| | as allow the user to specify the forwarded account |
| | name as the reply-to name. This allows the presence |
| | of the anti-spam service or software to be |
| | transparent. Also known as “Domain Name Support” |
| Architecture: Browser-based Service | This certification verifies that the system under test is |
| | implemented as a remote service requiring no end-user |
| | software beyond an industry-standard browser. |
| Architecture: Server-based Service | This certification verifies that the system under test is |
| | implemented as a remote service requiring no end-user |
| | software beyond industry-standard SMTP, IMAP or |
| | POP3 on the end user side. |
| Architecture: Application on Local PC Client | This certification verifies that the system under test is |
| | implemented as software resident in the local client. |
| Architecture: Local Server Application | This certification verifies that system under test is |
| | implemented as a server (or appliance) local to the |
| | end-user's data center. |
| Email Client Support: Internet Message Access Protocol | This certification verifies that the system under test |
| (IMAP) | can function with clients that implement IMAP Version 4 |
| | Revision 1 as defined in IETF RFC 3501. (Note: IMAP |
| | V4 is defined in RFC1730.) |
| Email Client Support: Post Office Protocol Version 3 | This certification verifies that the system under test |
| (POP3) | can function with clients that implement POP3 as |
| | defined in IETF RFC 1939 |
| External Email Account Support: Internet Message | This certification verifies that the system under test |
| Access Protocol (IMAP) | can automatically download and process (I.e., provide |
| | the anti-spam service) email from an external account |
| | using the IMAP Version 4 Revision 1 protocol as |
| | defined in IETF RFC 3501. |
| External Email Account Support: Post Office Protocol | This certification verifies that the system under test |
| Version 3 (POP3) | can automatically download and process (I.e., provide |
| | the anti-spam service) email from an external account |
| | using the POP3 protocol as defined in IETF RFC 1939. |
| “Bulk Load” of “Approved Senders” (Whitelist) | This certification verifies that the system under test |
| | provides a method to pre-load a list of approved |
| | senders via file import or scan of the user's inbox. |
| “Bulk Load” of “Blocked Senders” (Blocklist) | This certification verifies that the system under test |
| | provides a method to pre-load a list of blocked senders |
| | via file import. |
| Explanation of Presence on “Approved List” | This certification verifies that the system under test |
| | provides information showing why a given user was |
| | placed on the list. |
| Explanation of Presence on “Blocked List” | This certification verifies that the system under test |
| | provides information showing why a given user was |
| | placed on the list. |
| Activate/Deactivate “Challenge/Response” Behavior | This certification verifies that the system under test |
| | provides a way to activate and deactivate the |
| | challenge/response mechanism. |
| QoS - Two Traffic Queues | This certification verifies that a device is capable of |
| | segmenting QoS traffic into two unique and separate |
| | priority queues. |
| System Upgrade via HTTP (Hypertext Transfer Protocol) | This certification verifies that system under test |
| | supports upgrading of system software and/or |
| | firmware via HTTP |
| Basic TTY over IP - G.711 | This certification verifies that the system under test |
| | can provide basic transport (error rate <1%), using a |
| | G.711 vocoder, of TTY over an IP transport |
| | experiencing no packet loss. |
| Robust TTY over IP - G.711 | This certification verifies that the system under test |
| | can provide robust (error rate <1%) transport, using a |
| | G.711 vocoder, of TTY over an IP transport |
| | experiencing 5% packet loss. |
| Basic TTY over IP - G.729 | This certification verifies that the system under test |
| | can provide basic transport (error rate <1%), using a |
| | G.729 vocoder, of TTY over an IP transport |
| | experiencing no packet loss. |
| Robust TTY over IP - G.729 | This certification verifies that the system under test |
| | can provide robust (error rate <1%) transport, using a |
| | G.729 vocoder, of TTY over an IP transport |
| | experiencing 5% packet loss. |
| Audible Notification - “Message Waiting” on | This certification verifies that the system under test |
| | generates an audible message when the message |
| | waiting lamp changes state from “unlit” to “lit”. |
| Audible Notification - Line “On-hold” | This certification verifies that the system under test |
| | generates an audible confirmation message when the |
| | line is placed “on-hold”. |
| Audible Notification - Line “Off-hold” | This certification verifies that the system under test |
| | generates an audible confirmation message when a |
| | line that is on-hold becomes idle as a result of the held |
| | party hanging up. |
| Audible Notification - Line Appearance of Incoming Call | This certification verifies that the system under test |
| | generates an audible message notifying the user |
| | which line appearance to answer on an incoming call. |
| Audible Notification - Station Status “On-demand” | This certification verifies that the system under test |
| | allows the user to request an audible playback of |
| | station status, including status of all line appearances, |
| | message waiting status and all toggle-able |
| | buttons/lamps. |
| Caller ID - Text to Speech | This certification verifies that the system under test |
| | allows the user to request an audible playback of the |
| | display contents when there is an incoming call. |
| Caller ID - Text to Speech - “On-demand Privacy” | This certification verifies that the system under test |
| | allows the user to control whether an incoming |
| | call produces an audible playback of the display |
| | contents. |
| Voice Carry Over (VCO) | This certification verifies that the system under test |
| | can provide for a TTY that is physically or virtually |
| | linked to a telephone (IP or digital) to allow the user to |
| | speak to the other party via the handset and/or |
| | speakerphone. |
| Hearing Carry Over (HCO) | This certification verifies that the system under test |
| | can provide for a TTY that is physically or virtually |
| | linked to a telephone (IP or digital) to allow the user to |
| | listen to the other party via the handset and/or |
| | speakerphone. |
| Non-disruptive “Mute” in Voice Carry Over (VCO) or | This certification verifies that the system under test |
| Hearing Carry Over (HCO) | can provide for a TTY that is physically or virtually |
| | linked to a telephone (IP or digital) to continue to |
| | function in either VCO or HCO mode when the “mute” |
| | button the telephone set is activated.. |
| Simultaneous TTY and “Touch tone” | This certification verifies that the system under test |
| | can provide for a TTY that is physically or virtually |
| | linked to a telephone (IP or digital) to allow the user to |
| | make use of “touch tone” keys while the TTY device is |
| | also active. |
| Speed-dial Keys for TTY Call Initiation | This certification verifies that the system under test |
| | can provide for a TTY that is physically or virtually |
| | linked to a telephone (IP or digital) to allow the user to |
| | make use of speed-dial keys on that telephone to |
| | initiate a TTY call. |
| TTY Default Mode for Messaging | This certification verifies that when a TTY user's |
| | phone is not answered it can be automatically sent to a |
| | message system that can default to TTY messages |
| | and prompt with TTY prompts. |
| “Single Number Reach” - Optional TTY Greetings and | This certification verifies that a caller to an |
| Prompts | unanswered number can selectively switch from voice |
| | prompting to TTY for prompting (and vice versa). |
| TTY Login to Message System | This certification verifies that a messaging system |
| | mailbox owner can login and interact with the |
| | messaging system with a directly connected TTY and |
| | co-located IP phone. |
| Voice Carry Over (VCO) Messaging | This certification verifies that for a user with a directly |
| | connected TTY and a co-located IP phone, voice |
| | messages can be recorded when TTY prompts are |
| | provided on the messaging system. |
| Hearing Carry Over (HCO) Messaging | This certification verifies that for a user with a directly |
| | connected TTY and a co-located IP phone, prompts |
| | can be received using voice and replied to with touch |
| | tone - both via the co-located IP phone. However, |
| | messages can be recorded using the TTY device. |
| Message Header Information via TTY | Verify that a directly connected TTY subscriber |
| | accessing the messaging system on a co-located IP |
| | phone can log into and see message header |
| | information displayed on the TTY device. |
| Break into TTY Prompt with “Touch tone” Response | This certification verifies that during playback of a |
| | prompt on a directly connected TTY device that the |
| | calling party, using a co-located IP phone, can interrupt |
| | the TTY prompt with a “touch tone” response. |
| Different Security Policy per SSID | This certification verifies that the WLAN switch |
| | supports security options configurable by SSID. |
| Distributed Access Point | This certification verifies that the WLAN switch |
| | implements a “distributed access point” whereby |
| | multiple radio hubs appear as a single logical access |
| | point exposing the same BSSID, runnig on the same |
| | RF channel and not requiring an 802.11 association as |
| | clients communications move between the radios. |
| Redundant Power Management Module | This certification verifies that the device under test |
| | provides a backup power management module - |
| | separate from the normal power supply |
| Redundant System Management Module | This certification verifies that the device under test |
| | provides a backup system management module - |
| | separate from the primary system management module |
| Dynamic, Variable-speed Fan | This certification verifies that the device under test |
| | provides an air cooling system that can adjust fan |
| | speed in response to environmental temperature |
| | changes. |
| IPv4 - RIP v1 - Routing Protocol Support | This verifies that the device can exchange IPv4 |
| | routing table information via RIP Version 1 with the |
| | Cisco 175x-class router. (The 1751 is assumed to |
| | have code interoperable with other Cisco devices.) |
| IPv4 - RIP v2 - Routing Protocol Support | This verifies that the device can exchange IPv4 |
| | routing table information via RIP Version 2 with the |
| | Cisco 175x-class router. (The 1751 is assumed to |
| | have code interoperable with other Cisco devices.) |
| IPX - Routing Protocol Support | This verifies that the device can exchange IPX routing |
| | table information with the Cisco 175x-class router. |
| | (The 1751 is assumed to have code interoperable with |
| | other Cisco devices.) |
| IPv4 - OSPF - Routing Protocol Support | This verifies that the device can exchange IPv4 |
| | routing table information via OSPF with the Cisco 175x- |
| | class router. (The 1751 is assumed to have code |
| | interoperable with other Cisco devices.) |
| PIM Dense Mode - IP Multicasting | This verifies a devices ability to host and join IP |
| | multicast groups via PIM DM in a network that includes |
| | the Cisco 175x-class router.(The 1751 is assumed to |
| | have code interoperable with other Cisco devices.) |
| PIM Sparse Mode - IP Multicasting | This verifies a devices ability to host and join IP |
| | multicast groups via PIM SM in a network that includes |
| | the Cisco 175x-class router.(The 1751 is assumed to |
| | have code interoperable with other Cisco devices.) |
| PPP Basic Operation (No Authentication) | This certification verifies that the device under test can |
| | communicate with the Cisco 175x-class router using |
| | PPP with no authentication protocol. (The 1751 is |
| | assumed to have code interoperable with other Cisco |
| | devices.) |
| PPP Multilink Operation | This certification verifies that the device under test can |
| | communicate with the Cisco 175x-class router using |
| | PPP Multilink (RFC 1990). Use of an authentication |
| | protocol is optional. (The 1751 is assumed to have |
| | code interoperable with other Cisco devices.) |
| PPP - PAP Authentication | This certification verifies that the device under test can |
| | communicate with the Cisco 175x-class router using |
| | PPP (RFC 1331) with the Password Authentication |
| | Protocol (PAP) as defined in RFC 1334. (The 1751 is |
| | assumed to have code interoperable with other Cisco |
| | devices.) |
| PPP - CHAP Authentication | This certification verifies that the device under test can |
| | communicate with the Cisco 175x-class router using |
| | PPP (RFC 1331) with the Challenge-Handshake |
| | Authentication Protocol (CHAP) as defined in RFC |
| | 1334. (The 1751 is assumed to have code |
| | interoperable with other Cisco devices.) |
| HDLC Operation | This certification verifies that the device under test can |
| | communicate with the Cisco 175x-class router using |
| | the HDLC line protocol. (The 1751 is assumed to have |
| | code interoperable with other Cisco devices.) |
| Frame Relay Operation | This certification verifies that the device under test can |
| | communicate with the Cisco 175x-class router using |
| | the Frame Relay line protocol. (The 1751 is assumed to |
| | have code interoperable with other Cisco devices.) |
| 802.1p/Q VLAN Tag Propagation | This verifies that the device can properly identify and |
| | propagate frames carrying IEEE 802.1p/Q VLAN tags |
| | with priority bits set. |
| Virtual Router Redundancy Protocol (VRRP) | This verifies a device's ability to act as a standby |
| | router in the event of failure using VRRP standards in a |
| | network including a Cisco router. |
| VPN IPSec Interoperability | This verifies that the device can properly set up a VPN |
| | connection (3DES/SHA1) with a partner Cisco router |
| Host System Support - IBM PC Compatible | This certification verifies that the embedded system |
| | can operate in a PCI-slot of an IBM PC Compatible host |
| | system |
| Host System Support - Sun SPARC System | This certification verifies that the embedded system |
| | can operate in a PCI-slot of a SUN Microsystems |
| | SPARC-based host system |
| Host System Support - Apple Mac G4 System | This certification verifies that the embedded system |
| | can operate in a PCI-slot of an Apple Mac G4 host |
| | system |
| “SONET Class” Rapid Reconfiguration Spanning Tree | This certification verifies that the device under test can |
| Support (802.1w) | reconfigure its layer 2 spanning tree using the IEEE |
| | 802.1w “rapid” option in less than the 50 millisecond |
| | recovery (average of both directions) usually |
| | associated with SONET networks. |
| “SONET Class” Protection Switching | This certification verifies that a pair of devices can |
| | reconfigure and resume communication in less than the |
| | 50 millisecond recovery time (average of both |
| | directions) usually associated with SONET networks. |
| Zero-impact “In Service” ACL Update | This certification verifies that the normal performance |
| | level of the switch is not degraded when applying an |
| | Access Control List containing 25,000 (or more) entries |
| Zero-impact “In Service” BGP Route Update | This certification verifies that the normal performance |
| | level of the switch is not degraded when learning |
| | 155,000 (or more) BGP routes. |
| Zero-impact “Resistance” to DoS Attack: SYN Flood | This certification verifies that the normal performance |
| | level of the switch is not degraded when processing |
| | traffic from a SYN Flood of 1 million Source/Destination |
| | Address |
| Zero-impact “Resistance” to DoS Attack: PING Flood | This certification verifies that the normal performance |
| | level of the switch is not degraded when processing |
| | traffic from a PING Flood of 1 million Source/Destination |
| | Address |
| Link Aggregation (IEEE 802.3ad) - Cross Blade | This certification verifies that the device implements |
| | standards-based Link Aggregation and can create a |
| | single logical switch-to-switch link from two or more |
| | physical switch ports located on different blades. |
| Port Mirroring - Cross Blade | This certification verifies that the device under test can |
| | duplicate the traffic associated with a given port to |
| | another port on a different blade of the device under |
| | test. |
| 802.1X - Single port, “Per-MAC” Authentication | This certification verifies that the DUT offers a granular |
| | authentication process that allows a per-user (L2 |
| | MAC address) level of authentication rather than |
| | opening the part to all traffic once a single user has |
| Dynamic VLAN Assignment after Authentication | This certification verifies that the DUT can dynamically |
| | re-assign a port to an 802.1Q VLAN as part of the |
| | authentication process. |
| Web Browser-based Authentication | This certification verifies that the DUT can dynamically |
| | generate a web browser-based login/authentication |
| | screens for use by clients not configured for 802.1X |
| | authentication. |
| URL “Hijacking” | This certification verifies that the DUT can dynamically |
| | intercept a users browser traffic to redirect to another |
| | configured URL address. |
| URL Automatic Redirect after Authentication | This certification verifies that the DUT can dynamically |
| | redirect the user's browser to a configured URL after |
| | a successful authentication. |
| E1 Zero-loss, Full-duplex, two-port Throughput Results - | The certification establishes the aggregate packet and |
| 64-byte Packets | Mbit/s throughput of the device under test. |
| E1 Zero-loss, Full-duplex, two-port Throughput Results - | The certification establishes the aggregate packet and |
| 128-byte Packets | Mbit/s throughput of the device under test. |
| E1 Zero-loss, Full-duplex, two-port Throughput Results - | The certification establishes the aggregate packet and |
| 256-byte Packets | Mbit/s throughput of the device under test. |
| E1 Zero-loss, Full-duplex, two-port Throughput Results - | The certification establishes the aggregate packet and |
| 512-byte Packets | Mbit/s throughput of the device under test. |
| E1 Zero-loss, Full-duplex, two-port Throughput Results - | The certification establishes the aggregate packet and |
| 1,024-byte Packets | Mbit/s throughput of the device under test. |
| E1 Zero-loss, Full-duplex, two-port Throughput Results - | The certification establishes the aggregate packet and |
| 1,518-byte Packets | Mbit/s throughput of the device under test. |
| Ethernet (10 Mbit/s) Layer 3 Zero-loss, Full-duplex, | The certification establishes the aggregate packet and |
| two-port Throughput Results - 64-byte Packets | Mbit/s throughput of the device under test.OSPF |
| | routing is enabled on the device but no other functions, |
| | such as access control lists or firewall functionality, |
| | are enabled. |
| Ethernet (10 Mbit/s) Layer 3 Zero-loss, Full-duplex, | The certification establishes the aggregate packet and |
| two-port Throughput Results - 128-byte Packets | Mbit/s throughput of the device under test.OSPF |
| | routing is enabled on the device but no other functions, |
| | such as access control lists or firewall functionality, |
| | are enabled. |
| Ethernet (10 Mbit/s) Layer 3 Zero-loss, Full-duplex, | The certification establishes the aggregate packet and |
| two-port Throughput Results - 256-byte Packets | Mbit/s throughput of the device under test.OSPF |
| | routing is enabled on the device but no other functions, |
| | such as access control lists or firewall functionality, |
| | are enabled. |
| Ethernet (10 Mbit/s) Layer 3 Zero-loss, Full-duplex, | The certification establishes the aggregate packet and |
| two-port Throughput Results - 512-byte Packets | Mbit/s throughput of the device under test.OSPF |
| | routing is enabled on the device but no other functions, |
| | such as access control lists or firewall functionality, |
| | are enabled. |
| Ethernet (10 Mbit/s) Layer 3 Zero-loss, Full-duplex, | The certification establishes the aggregate packet and |
| two-port Throughput Results - 1024-byte Packets | Mbit/s throughput of the device under test.OSPF |
| | routing is enabled on the device but no other functions, |
| | such as access control lists or firewall functionality, |
| | are enabled. |
| Ethernet (10 Mbit/s) Layer 3 Zero-loss, Full-duplex, | The certification establishes the aggregate packet and |
| two-port Throughput Results - 1,518-byte Packets | Mbit/s throughput of the device under test.OSPF |
| | routing is enabled on the device but no other functions, |
| | such as access control lists or firewall functionality, |
| | are enabled. |
| Fast Ethernet (100 Mbit/s) Layer 3 Zero-loss, Full- | The certification establishes the aggregate packet and |
| duplex, two-port Throughput Results - 64-byte Packets | Mbit/s throughput of the device under test.OSPF |
| | routing is enabled on the device but no other functions, |
| | such as access control lists or firewall functionality, |
| | are enabled. |
| Fast Ethernet (100 Mbit/s) Layer 3 Zero-loss, Full- | The certification establishes the aggregate packet and |
| duplex, two-port Throughput Results - 128-byte Packets | Mbit/s throughput of the device under test.OSPF |
| | routing is enabled on the device but no other functions, |
| | such as access control lists or firewall functionality, |
| | are enabled. |
| Fast Ethernet (100 Mbit/s) Layer 3 Zero-loss, Full- | The certification establishes the aggregate packet and |
| duplex, two-port Throughput Results - 256-byte Packets | Mbit/s throughput of the device under test.OSPF |
| | routing is enabled on the device but no other functions, |
| | such as access control lists or firewall functionality, |
| | are enabled. |
| Fast Ethernet (100 Mbit/s) Layer 3 Zero-loss, Full- | The certification establishes the aggregate packet and |
| duplex, two-port Throughput Results - 512-byte Packets | Mbit/s throughput of the device under test.OSPF |
| | routing is enabled on the device but no other functions, |
| | such as access control lists or firewall functionality, |
| | are enabled. |
| Fast Ethernet (100 Mbit/s) Layer 3 Zero-loss, Full- | The certification establishes the aggregate packet and |
| duplex, two-port Throughput Results - 1,024-byte | Mbit/s throughput of the device under test.OSPF |
| Packets | routing is enabled on the device but no other functions, |
| | such as access control lists or firewall functionality, |
| | are enabled. |
| Fast Ethernet (100 Mbit/s) Layer 3 Zero-loss, Full- | The certification establishes the aggregate packet and |
| duplex, two-port Throughput Results - 1,518-byte | Mbit/s throughput of the device under test.OSPF |
| Packets | routing is enabled on the device but no other functions, |
| | such as access control lists or firewall functionality, |
| | are enabled. |

Having thus described the invention in detail, it is to be understood that the foregoing description is not intended to limit the spirit and scope thereof. What is desired to be protected by Letters Patent is set forth in the appended claims.

1. A method for testing and certifying an aspect of a device comprising:
applying a test to an aspect of the device;
gathering results of the test;
comparing the results to one or more pre-determined standards;
certifying the device and publishing test results in an online results catalog if the results meet or exceed the one or more pre-determined standards; and
communicating a failure to a product vendor if the results do not meet or exceed the one or more pre-determined standards.

2. The method of claim 1, wherein the step of applying the test comprises applying a pre-defined test to the aspect of the device.

3. The method of claim 2, wherein the product vendor chooses the pre-defined test from an online tests catalog.

4. The method of claim 1, wherein the step of applying a test comprises applying a user-specified test to the aspect of the device.

5. The method of claim 4, wherein user-specified tests are incorporated into an online test catalog of pre-defined tests for review and use by other vendors.

6. The method of claim 1, wherein the step of applying the test comprises applying a performance test to a computing device.

7. The method of claim 1, further comprising licensing a certification logo to a product vendor if the results meet or exceed the one or more pre-determined standards.

8. The method of claim 1, wherein the step of communicating the failure to the vendor comprises transmitting an e-mail or facsimile to the vendor indicating the failure.

9. The method of claim 1, further comprising testing and certifying additional aspects of the device.

10. A method of allowing a user to test and certify a device comprising:
submitting a product to be tested to a testing entity;
identifying a test to be performed on the product;
allowing the testing entity to perform the test on the product;
receiving a communication from the testing entity indicating testing results;
reviewing testing results in an online results catalog and displaying a certification logo in connection with the product if the product passes the test; and
improving the product if the product fails the test.

11. The method of claim 10, wherein the step of submitting the product comprises submitting a network or computing device to the testing entity.

12. The method of claim 11, wherein a product vendor chooses a test from an online tests catalog.

13. The method of claim 10, wherein the step of identifying the test comprises identifying a pre-defined or user-specified test.

14. The method of claim 13, wherein user-specified tests are incorporated into an online tests catalog for review and use by vendors.

15. The method of claim 10, further comprising allowing the user to configure parameters of the test prior to testing.

16. The method of claim 10, wherein the step of receiving the communication comprises receiving an e-mail or facsimile from the testing entity indicating test results.

17. The method of claim 10, further comprising allowing the user to specify additional tests to be performed on the device.

18. A system for testing and certifying a device comprising:
a web server providing a web site for allowing a product vendor to specify one or more tests to be performed;
a testing entity for performing the one or more tests on the product;
a certification server in communication with the web server, the certification server including an online results catalog for storing product information and tests results relating to the product; and
a communications interface connected to the web server for allowing one or more remote users to access the web server.

19. The system of claim 18, wherein the product vendor chooses a pre-defined test from an online tests catalog.

20. The system of claim 18, wherein the one or more tests comprises a user-specified test applied to an aspect of the device.

21. The system of claim 20, wherein user-specified tests are incorporated into an online tests catalog of pre-defined tests for review and use by other vendors.

22. The system of claim 18, wherein the testing entity certifies the product if the product passes the one or more tests.

23. The system of claim 22, further comprising a certification logo licensed from the testing entity to the product vendor if the product passes the one or more tests.

24. The system of claim 18, wherein the online catalog further comprises a certification database for storing certification information and a product database for storing product information.

25. The system of claim 18, wherein the online catalog is accessible via the Internet.

26. A method for testing and certifying Voice-over-IP (VoIP) capabilities of a device comprising:
connecting the device between two end nodes;
establishing a VoIP call between the two end nodes and across the device;
testing voice quality of the call using a voice quality tester;
comparing tests results to pre-determined standards;
certifying the product as having VoIP capability and storing testing results in an on-line results catalog of the results meet or exceed the pre-determined standards; and
communicating a failure to the product vendor if the results do not meet or exceed the pres-determined standards.

27. The method of claim 26, wherein a product vendor chooses a pre-defined test from an online tests catalog.

28. The method of claim 26, wherein the step of testing voice quality comprises applying a user-specified test to the device.

29. The method of claim 26, further comprising applying PESQ and PSQM algorithms to the device to determine voice quality during the call.

30. The method of claim 26, further comprising generating traffic across the device using one or more traffic generators prior to testing voice quality.

31. The method of claim 30, further comprising enabling Quality-of-Service (QoS) features of the device prior to testing voice quality.
